(19) United States
(12) Patent Application Publication
(10) Pub. No.: US 2021/0231911 A1
(43) Pub. Date: Jul. 29, 2021

(54) LASER BEAM COMBINING AND DELIVERY SYSTEM

(71) Applicant: Oren Aharon, Haifa (IL)

(72) Inventor: Oren Aharon, Haifa (IL)

(21) Appl. No.: 16/775,289

(22) Filed: Jan. 29, 2020

(51) Int. Cl. G02B 7/182; B25J 9/04; B25J 9/10; G02B 5/12; G02B 19/00; G02B 7/04

(52) U.S. Cl. CPC G02B 7/182; B25J 9/042; B25J 9/102; G02B 7/04; G02B 19/0009; G02B 19/0047; G02B 5/12

(57) ABSTRACT

A unique electro optical robot design is disclosed, which includes hollow optical members creating a beam delivery system. The laser beam is coupled to an input aperture on the robotic arm and travels through hollow arms which rotate in respect to each other. Said input laser beam is delivered to a specific point in space within the reach of the arms with great accuracy. The arms themselves are designed to minimize angular deviations by using elongated periscopes or retroreflectors. This design is characterized by the ability to deliver a near collimated laser beam with great accuracy and capable of fusing together several laser beams of different wavelengths. Moreover, since the laser beam travels in a collimated mode, a lightweight focuser is the only necessary optical element, thus significantly reducing the load on the end tip of said robotic arms. The purpose of this invention is to offer a multi wavelengths accurate beam delivery system, acting in a robotic mode.

### BACKGROUND OF THE INVENTION

Traditional laser beam delivery systems rely on delivering laser energy into a single focal spot, and positioning this spot on the target material. This delivery process is performed either by fiber optic high power laser or by a combination of reflective mirrors installed in special developed hollow joints. Advances in light manipulation as disclosed in this novel art show a beam delivery system based on optical periscopes or elongated retroreflectors which will deliver a beam from point to point for most existing wavelengths with high accuracies overcoming most restrictions found in traditional art.

Laser based Electro-Optic systems are often required to deliver a beam from one point to another. Furthermore, seldom a combination of a number of separate laser beams into a single beam is required. The need to provide a multi-spectral content along with extremely high-power levels is a common practice for industrial lasers, particularly for material processing or fast welding and brazing applications. Those needs have led to a development of flexible fiber lasers which are attached to a robotic arm to deliver the beam from point to point. However, fiber optic delivery systems, while very popular, lack the capability to deliver a significant number of laser wavelengths and perform very poorly when a number of lasers are coupled as a single fiber. Moreover, the fiber technology requires installation of a complicated and heavy end piece at the guiding robotic arm used to deliver the fiber optics energy to working area. This complicated and sometimes very heavy end piece will dictate a large robot capable to carry this extra weight. Said end piece usually includes a fiber laser collimator, a focuser, a camera and gas cooling fittings.

### SUMMARY OF THE INVENTION

In disclosed art, we show that said beam delivery systems based on periscope or on elongated retroreflector have the advantages of delivery of increased number of lasers over a wide spectral range without the restriction common to fiber optics systems and with inherent accuracies superior to reflective mirror technologies. Delivery of a multi-spectral laser beam having high-power levels, in order to meet various special material processing needs, usually cannot be performed using optical fibers or simple refractive elements and require reflective mirror elements. Mirror based solutions require complicated rotating mirror knuckles with mechanical members in between and are adequate solution for delivering multi wavelength lasers or high peak power pulsed laser. One of most significant drawbacks of a mirror-based solution is its complication, which is derived from requirements of high precision delivery of high-power lasers over large distances in an industrial environment. The disclosed art introduces novel approaches to multi spectral beam delivery problem, which solves the inherent drawbacks of existing art.

The purpose of the present invention is to provide a multi wavelengths superior beam delivery system and beam combining device. Said device will be able to efficiently deliver a laser beam from a stationary laser device with high accuracy by using elongated optical members such as periscopes or retroreflector. By using said elongated members based on reflective periscopes the system is capable to deliver laser beams over a wide spectral range.

Said system is based on a manipulator with a number of axes and elongated members wherein said members are rotated in respect to each other, by a plurality of electric motors controlling the movement of the end point of said manipulators. The laser beam travels through said elongated members and joints to be delivered to the point of interest.

Trajectory is controlled by a programmable electronic control unit, placing a focused laser beam at any position in a relevant working space. Said manipulator has at least one movable lens across the laser beam path for focus adjustment. The possibility of delivering the laser beam to the point of interest with high accuracy without complicated and expensive mechanical devices considerable simplifies the beam delivery system while increasing its performance by allowing multiple wavelength to be applied together when necessary.

The basic configuration of disclosed system is comprised of a robotic device with a number of elongated periscopes connected together through a motorized rotating axis to control the rotational movement of said elongated periscopes. The laser beam is coupled to the system by an input port and it ends by an output port equipped with a focusing element. Said motorized rotating joints connect the periscopes to be concentric in respect to each other's input/output ends. The connecting motors are coupled to a computer processing with an algorithm configured to control driving motors to complete a trajectory in space and activate the said focusing element. Moreover, the hollow robotic arm will have a positive flow of clean gas to actively cool the system and ensure its cleanliness. The said motors could be based on a mechanism of hollow axis gear motors. The said focusing element will be mounted on the external envelope of robotic arm, engulfing said periscopes. In addition, the focusing element could be based on a mirror as a part of the elongated periscope. Said elongated periscopes could be replaced in a yet another configuration by elongated retroreflectors.

The present invention offers a method and device which is free from disadvantages limiting performance of current art.

### BRIEF DESCRIPTION OF THE DRAWINGS

Further advantages of the invention will emerge from the following descriptions and drawings, which are provided as non-limiting example and in which:

FIG. 1 is a perspective view of a manipulator robot according to a first embodiment of the present invention;

FIG. 2 is a cross-section of the manipulator robot according to first embodiment.

FIG. 3 is a cross-section of the manipulator robot according to second embodiment.

FIG. 4 is perspective view of the laser tracing through the elongated periscopes and focusing lens.

FIG. 5 is perspective view of the laser tracing through the elongated periscopes and focusing lens, showing the system's insensitivity to angular deviations of one of said periscopes.

FIG. 6 is a perspective view including laser tracing of a system based on elongated retroreflector members showing the working principle using 180 degrees deflection retroreflector member.

### DETAILED DESCRIPTION OF THE DRAWINGS

Laser material processing is performed by concentrating laser energy into a focused beam in order to achieve high levels of fluence on material surface, this is usually performed by focusing a collimated beam by an optical element usually denoted as focuser.

The main problematic issues with this technology are positioning errors and the laser type especially when dealing with pulsed laser or its wavelength. The focused laser beam is approximately Gaussian, with a relatively short focal range and a beam size down to several micrometers.

Consequently, positioning error of delivered beam or variation on material surface can lead to inconsistency and poor machining quality. In described art we present a solution based on beam delivery members that accurately deliver the beam regardless the mechanical positioning errors of said members adopting members such as elongated periscopes and elongated retroreflectors, to deliver an almost collimated beam to the required position and then at this far end using a light focuser for creating the necessary beam size. Using this strategy will create a multi wavelength high power beam delivery system with superior accuracies.

A periscope is a device built by two laterally offsets parallel mirrors. The mirror surfaces, if perfectly parallel, will reflect an incoming beam with an offset creating an outcoming beam which is laterally displaced but parallel to incoming beam. If the mirror surfaces are perfectly parallel, the input output parallelism will be preserved regardless of mechanical movement of housing holding the said mirrors together. This enables to preserve parallelism without precisely maintaining the mechanical datum plane of housing. An elongated retroreflector is built out of three perpendicular mirrors section held together by a stretched housing and an incoming beam will be laterally displaced wherein the resulting outgoing beam will be exactly 180 decrees to incoming beam. Combining by a rotary joint several elongated periscopes or a combination of periscopes with elongated retroreflector a beam can be positioned within a circular area having a radius traced by the length of the stretched members. This outcoming beam will always be parallel to incoming beam by definition.

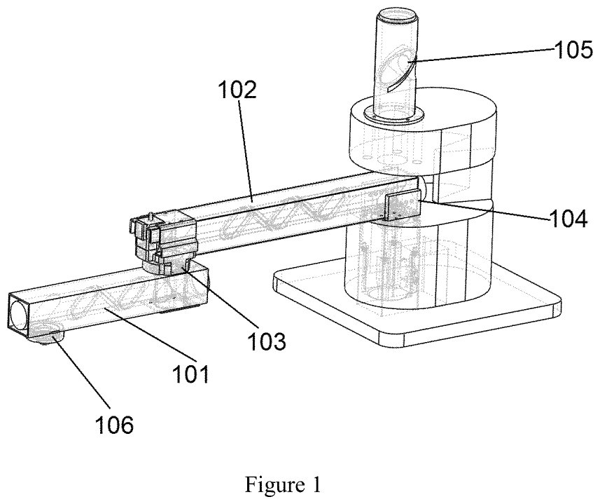

FIG. 1 is a preferred embodiment which includes all the necessary components. Two members with a rectangular cross-section denoted as 101 and 102 respectively are attached to the shafts of two motors denoted as 103 and 104 respectively. A laser beam is coupled into the system through an input orifice denoted as 105 and travels through inner elongated periscopes or elongated retroreflectors (both not shown in the drawing) towards the exit focusing lens denotes as 106. By rotating said shafts, the end focusing lens can be positioned in a wide area according to the amount of rotation and relative position of said shafts. The focusing lens will focus the beam at the position as dictated by the angular position of said shafts.

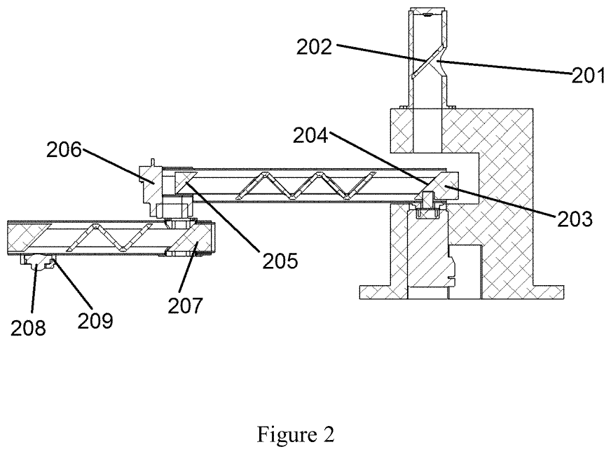

In FIG. 2 a cross-section of the laser beam manipulator robot is disclosed, wherein input orifice 201 is used for coupling the laser beam towards the mirror 202, which further folds the laser beam towards the first periscope denoted as 203. Said periscope has two reflective surfaces 204 and 205 which are parallel to each other, so that the laser beam travels between them and exits perfectly parallel to input direction. The beam travels through the connecting shaft denoted as 206, to a second periscope denoted as 207, and is then folded to exit perfectly parallel to input direction of original laser beam. The said laser beam is then focused by lens denoted as 208. Said lens is vertically moved by motor 209 to focus the input laser beam at various vertical distances. To summarize, the input laser beam is folded, transferred through hollow periscopes and further focused by a focusable lens. The hollowed trajectory of the laser beam could be filled with pressurized air for cooling and laser protection. As a result, robotic beam delivery system is disclosed, capable to position a focused laser beam within a given area by changing the relative rotation between several members with periscopes. It is important to note that because of the periscopes which deliver the laser beam from one end to the second in a parallel matter, independent of minute angular mistakes of said periscopes.

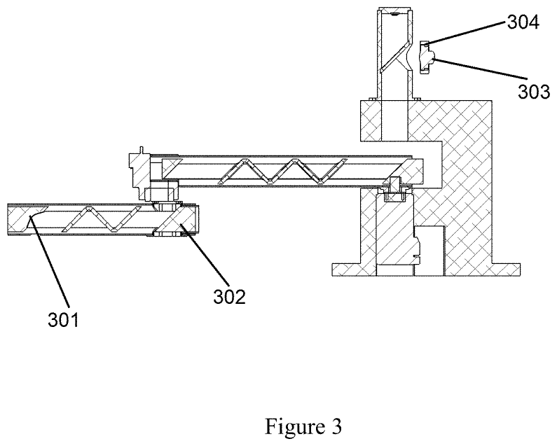

FIG. 3 is an identical mechanical configuration to the mechanics disclosed in FIG. 2, wherein the focusing lens is replaced by a concave mirror surface 301 built in to periscope denoted as 302. For beam vertical focusing, an input lens denoted as 303 is moved in parallel by motor denoted as 304.

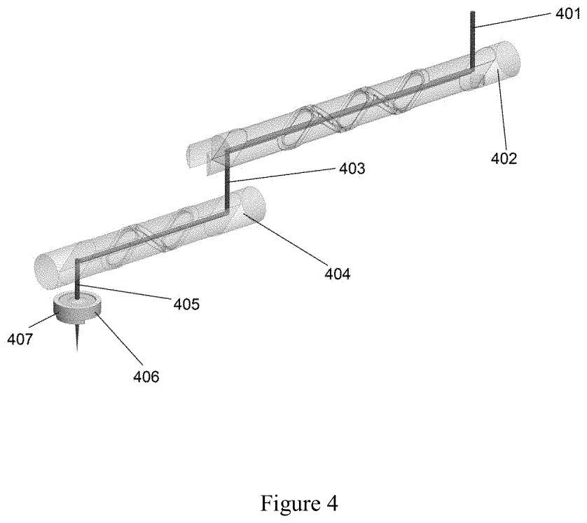

FIG. 4 further clarifies the laser beam trajectory through the periscopes. The laser beam denoted as 401 first travels through periscope denoted as 402 and exits parallel to input and is then denoted as 403. Further traveling through second periscope 404 and its exit position is denoted as 405. Periscopes have rotational members (not shown) along beams 401 and 403 for mechanical positioning purposes. Lens denoted as 406 moves along vertical axis by motor 407 and shifts the focal position of laser beam along said vertical axis.

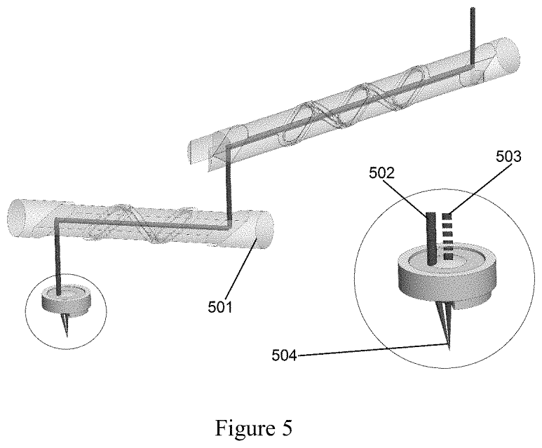

FIG. 5 shows a perspective view of the laser ray tracing through the elongated periscopes, emphasizing the built in capability of those devices. Periscope denoted as 501 was intentionally rotated to an upper position, mimicking a possible unwanted mechanical deviation. The ray trace which follows the periscopic device behavior ensures that the output beam denoted as 502 is still parallel to the input position. This parallel beam, when reaching the focusing lens at a different position on its surface, will focus the laser beam at exactly the same position which will be free from said mimicking error. Thus, cancelling the error and keeping the overall system accuracy at high levels in spite of a possible mechanical error.

The encircled detailed view shows an original beam 503 in a perfect position focusing at the point denoted as 504. The deviated beam 502 being parallel to the original beam will focus at the exact position with no offset. The lens focuses according to the law Δx=F×Δθ. Since Δθ represents the angular deviation between the two beams striking the focusing lens, and it equals to zero by definition, Δx at the focal point will be then zero as well.

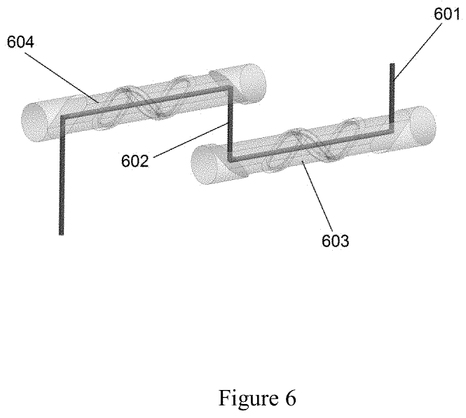

FIG. 6 is a perspective view including laser tracing of a system based on elongated retroreflector members showing the working principle using 180 degrees deflection retroreflector member. Input beam denoted as 601 is back-reflected by 180 degrees at the end of first elongated retroreflector. The reflected beam is denoted as 602 and the retroreflector is denoted as 603. After passing through a second elongated retroreflector member denoted as 604, the beam is reflected another 180 degrees, emerging from both members totally parallel to said 601 input direction.

1. A device for laser beam delivery system comprising:
a manipulator device with a number of elongated periscopes, having a number of rotating axes activated by a plurality of motors to control the rotational movement of said elongated periscopes;
a stationary nonrotating laser input port coupled with a output port having a periscope mounted on its top;
a plurality of elongated periscopes rotating in respect to each other having a mechanical joint connecting their axis of rotation to be concentric with respect to each other input to output position;
a driving motor mounted on said mechanical joint and activating the rotational movement of said periscopes to follow a programmed trajectory;
a laser focusing lens mounted onto the output end of last periscope; and
a computer processor comprising an algorithm configured to control said driving motors to complete said trajectory and activate the focus position of said focusing lens.

2. The device of claim 1 wherein a positive flow of clean gas is applied at the stationary input port adjacent to the said laser input port.

3. The device of claim 1 wherein the mechanism rotating the telescopes is based on a hollow axis gear and motor.

4. A device according to claim 1 wherein the said elongated periscopes are mounted inside an external envelope carrying the weight of said focusing lens.

5. A device according to claim 1 wherein the external envelope controls the position of said focusing lens.

6. A device according to claim 1 wherein the focusing is performed by an integrated mirror in said elongated periscope.

7. A method for laser beam delivery system comprising:
a manipulator device with a number of elongated retroreflectors, having a number of rotating axes activated by a plurality of motors to control the rotational movement of said elongated periscopes;
a stationary nonrotating laser input port coupled with an output port having a periscope mounted on its top;
a plurality of elongated retroreflectors rotating in respect to each other having a mechanical joint connecting their axis of rotation to be concentric with respect to each other input to output position;
a driving motor mounted on said mechanical joint and activating the rotational movement of said retroreflectors to follow a programmed trajectory;
a laser focusing lens mounted onto the output end of last retroreflector; and
a computer processor comprising an algorithm configured to control said driving motors to complete said trajectory and activate the focus position of said focusing lens.
